(19) United States
(12) Patent Application Publication
(10) Pub. No.: US 2010/0262753 A1
(43) Pub. Date: Oct. 14, 2010

(54) METHOD AND APPARATUS FOR CONNECTING MULTIPLE MEMORY DEVICES TO A CONTROLLER

(75) Inventors: Scott Richmond, Boulder, CO (US); John W. Williams, Longmont, CO (US)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/420,604

(22) Filed: Apr. 8, 2009

(51) Int. Cl. G06F 12/02

(52) U.S. Cl. 711/103; 711/E12.008

(57) ABSTRACT

A control system includes a controller having shared pins and unique pins for receiving and outputting signals from and to first and second memory devices. The first memory device includes signal lines which are electrically connected to shared pins, and the second memory device includes signal lines which are electrically connected to the shared pins together with the signal lines from the first memory device. The controller selectively inputs signals from and output signals to the first memory device and second memory device through the select shared pins.

### FIELD OF INVENTION

The present invention relates to controllers or microcontrollers, and in particular to controllers having input/output signal pads that are shared by multiple memory devices.

### BACKGROUND OF THE INVENTION

In some disk drives, a non-volatile memory such as a flash memory is used by the operating system (OS) or other utilities in addition to a buffer memory. In one application, for example, a flash memory is used to store a master boot record (MBR) program for booting the computer. Typically, the MBR program is stored on the disk medium of a disk drive. As such, the disk in the drive must spin up to the proper operating speed before the boot program can be accessed and executed. This takes time which many users find unsatisfactory. By storing the MBR program in a flash memory, the spin-up time is eliminated. This enables the computer system to boot much faster than computer systems employing a disk medium to store the boot program.

Adding a flash memory or other types of non-volatile memory devices to perform the function of a disk medium, however, requires additional input and output signal connections being added to the disk controller to accommodate the added memory device. This significantly increases the cost associated with manufacturing the disk controller.

### SUMMARY OF THE INVENTION

One embodiment of the present invention is directed to a control system including a controller having shared pins and unique pins for receiving and sending signals from and to a first memory device and a second memory device. A first memory device includes first signal lines which are electrically connected to pins shared pins, and a second memory device includes second signal lines which are electrically connected to the shared pins together with the first signal lines. The controller selectively inputs signals from and output signals to the first memory device and second memory device through the shared pins.

### BRIEF DESCRIPTION OF THE DRAWINGS

FIG. 1 is a wiring diagram showing the connections between a controller and multiple memory devices;

FIG. 2 is a schematic diagram of input and output circuitry associated with shared input and output pins in accordance with one embodiment of the present invention;

FIG. 3 illustrates input voltages that may be applied to the input circuitry shown in FIG. 2;

FIG. 4 illustrates output voltages that may be applied to the output circuitry shown in FIG. 2;

FIG. 5 is a schematic diagram of input and output circuitry associated with a shared input/output pin in accordance with another embodiment of the present invention; and

FIGS. 6A-6F are signal diagrams illustrating the operation of the disk controller and the memory devices shown in FIG. 1.

### DETAILED DESCRIPTION OF THE PREFERRED EMBODIMENTS

The present invention provides a cost saving measure in the manufacturing of a control system such as disk controllers that include a controller being connected to multiple memory devices. Selected signal pins on the controller are shared by (i.e., connected to) multiple memory devices, such as a buffer memory and a flash memory.

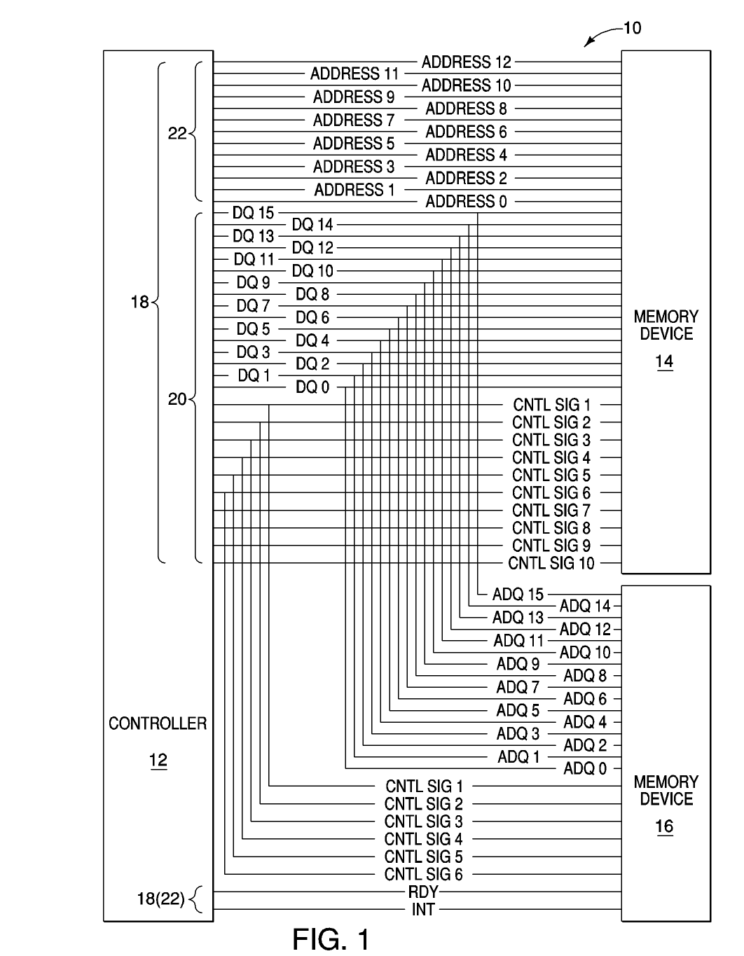

Turning now to FIG. 1, an exemplary control system 10 in accordance with one embodiment of the present invention includes a controller 12 connected to two memory devices 14, 16. In one embodiment, the control system 10 is implemented in a disk drive and the controller 12 is a disk controller, also known as a hard disk controller (HDC). While only two memory devices 14, 16 are shown in FIG. 1, as an example, the controller 12 may be connected to additional memory devices as dictated by function.

The controller 12 processes commands from a host device (not shown) connected to the disk drive in which the controller is provided, and accepts data from and transmits disk data to the host device. The controller 12 also provides signals for control and management of the mechanical positioning of the read/write heads and rotational media in the disk drive. The first memory device 14 may be a buffer memory for storing data used by the controller 12, and implemented using a dual data rate (DDR) DRAM or other known memory devices such as an SDRAM. The second memory device 16 may be a non-volatile memory device such as a flash memory including High Speed NAND. In one application, the second memory device 16 is employed in storing a master boot record (MBR) program required for booting the computer system in which the disk drive is operatively connected.

The controller 12 includes numerous input and output connectors or pins 18 for transmitting and receiving signals to and from the connected memory devices 14, 16. Of the pins 18, a select number of shared input and output pins 20 are connected to both first and second memory devices 14, 16, while the remaining unique input and output pins 22 are connected separately either to the first memory device 14 or the second memory device 16. For example, the pins 18 that are connected to the first memory device 14 through address lines 0-12 and pins that are connected by RDY and INT lines to the second memory device 16 are the unique pins 22. Shared pins 20 generally include those that are used for inputting/outputting control signals (CNTL SIG). When the first and second memory devices 14, 16 are DDR DRAM and High-Speed NAND devices, for example, signals for the system clock, chip select, row address strobe, column address strobe, write enable, etc, may be connected to the shared pins 20.

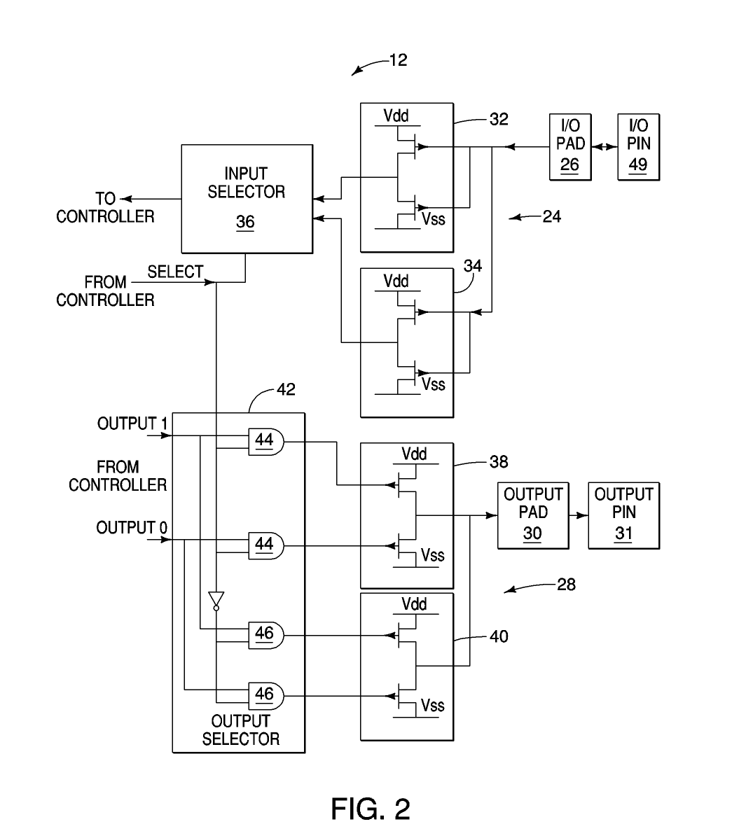

Turning now to FIG. 2, exemplary circuitry associated with shared input and output connectors or pins 20 of the controller 12 includes an input circuitry 24 connected to an input pad 26, and output circuitry 28 connected to an output pad 30. Input signal lines from both the first and second memory devices 14, 16 are physically and electrically connected to a corresponding shared input pin 29 via PCB, substrate traces or wires, and output signals from the controller 12 to both the first and second memory devices 14 are sent through corresponding shared output pin 31 via PCB, substrate traces or wires. The shared input pin 29 in turn is connected physically and electrically to the corresponding input pad 26, and the shared output pin 31 is connected physically and electrically to corresponding output pad 30.

The input circuitry 24 includes a first input structure 32 and a second input structure 34. Input signals received at the input pad 26 from the first and second memory devices 14, 16 are detected by a first input structure 32 and a second input structure 34, which have outputs that switch from a logic 1 to a logic 0, or from logic 0 to logic 1 at a predetermined input voltage at the input pad 26.

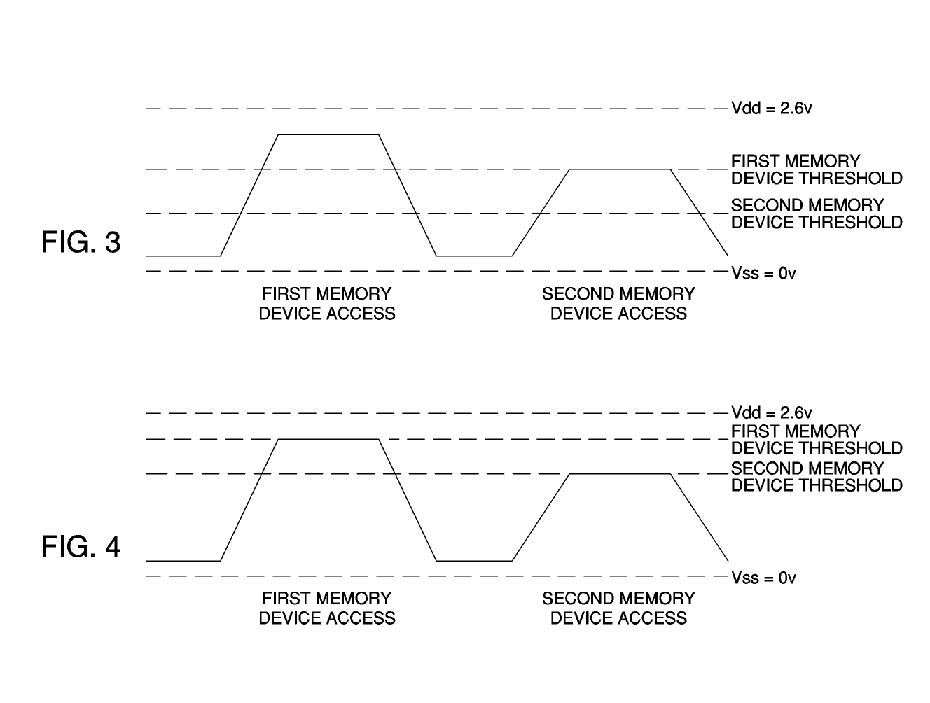

The first and second input structures 32, 34 correspond to the first and second memory devices 14, 16 and may have different threshold voltages at which the logic is switched. FIG. 3 illustrates input voltages that might be presented to the controller 12 from the first and second memory devices 14, 16. The first and second input structures 32, 34 switch logic at approximately 70-80% of Vdd for high transition and approximately 20-30% of Vdd for low transition. For example, the first input structure 32 may have a Vdd=2.6 v and the second input structure 34 a Vdd=1.8 v. In the example waveform in FIG. 3, the first input structure 32 switches to high at approximately 1.8 v, and the second input structure 34 at approximately 1.3 v. The logic states of the first and second input structures 32, 34 are then input to an input selector 36.

It should be understood that the different voltage levels at which the first and second memory devices 14, 16 operate is one reason for having two separate input structures 32, 34. Another reason might be different slew rates (rise and fall times) between the memory devices 14, 16 connected to the shared input pad 26.

Once the logic of the first and second input structures 32, 34 are input to the input selector 36, the controller 12 determines through a SELECT signal to the input selector 36 to select the input from the first or second input structures. The selected logic signal is then output by the input selector 36 to a buffer manager (not shown) in the controller 12. The first and second input structures 32, 34 are implemented using transistors, which function generally as pull up and pull down transistors such as a FET. The input selector 36 may be implemented using a multiplexer, for example.

The output circuitry 28 includes a first output structure 38 and a second output structure 40 from which output signals are sent to the first and second memory devices 14, 16 via the output pad 30. Each of the output structures 38, 40 receive voltages that enable them to output a logic 1 or 0 to the output pad 30. The signals for generating the logic 1 or 0 are received from an output selector 42 which has two outputs 1 and 0 for the output structure 38 and two outputs 1 and 0 corresponding to the output structure 40.

FIG. 4 illustrates an example of voltages output by the output selector 42 to the first and second output structures 38, 40. Similar to the first and second input structures 32, 34, the first and second output structures 38, 40 switch logic at approximately 70-80% of Vdd for high transition and approximately 20-30% of Vdd for low transition. The first output structure 38 has a Vdd=2.6 v and the second output structure 40 a Vdd=1.8 v, as in the first and second input structures 32, 34. In the example waveform in FIG. 4, the first output structure 38 switches to high at approximately 1.8 v, and the second output structure 40 at approximately 1.3 v. The logic states of the first and second output structures 38, 40 are then output to the output pad 30 and then to the first and second memory devices 14, 16 via the corresponding shared output pin 20.

Referring back to FIG. 2 and in operation, the output selector 42 outputs a voltage appropriate to generate a logic 1 if the first memory device 14 corresponding to the first output structure 38 is selected by the SELECT signal from the controller 12 and OUTPUT 1 signal also is active. Similarly, the output selector 42 outputs a voltage corresponding to a logic 1 to the second output structure 40 if the second memory device 16 is selected by the SELECT signal from the controller 12 and OUTPUT 1 signal from the controller is active. The output selector 42 outputs a voltage corresponding to a logic 0 to the output structure 38 if the first memory device 14 is selected and if OUTPUT 0 signal is active. Similarly, the output selector 42 outputs a voltage corresponding to a logic 0 to the output structure 40 if the second memory device 16 is selected and if OUTPUT 0 signal is active.

The output selector 42 includes AND gates 44, 46 that respectively select which output structure 38, 40 are enabled to drive a logic 1 or 0 to the first and second memory devices 14, 16 with the proper voltages for that interface. While the output selector 42 is implemented using a number of AND gates in FIG. 2, as an example, those skilled in the art will recognize that the output selector may be implemented using other components and arrangements in outputting the voltages corresponding to the intended logic 1 or 0.

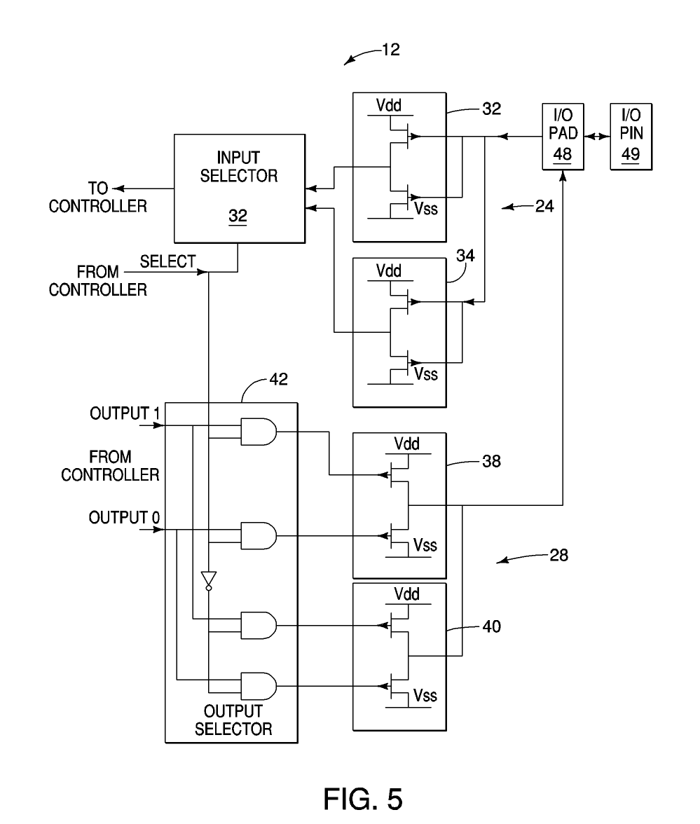

Turning now to FIG. 5 and in accordance with another embodiment of the present invention, the input and output circuitry 24, 28 are both connected to an I/O (i.e., bidirectional) pad 48. The input and output circuitry 24, 28 of this embodiment operate the same as when they are separately connected to input pad 26 and output pad 30, except the output circuitry 28 is placed in a Hi-Z or floating mode by driving the OUTPUT 1 and OUTPUT 0 signals to an active lower level, or “0”, by the controller 12 when the I/O pad 48 is in an input mode. In this embodiment, the I/O pad 48 is connected to a single corresponding shared input/output pin 49, which in turn is connected to both the first and second memory devices 14 and 16.

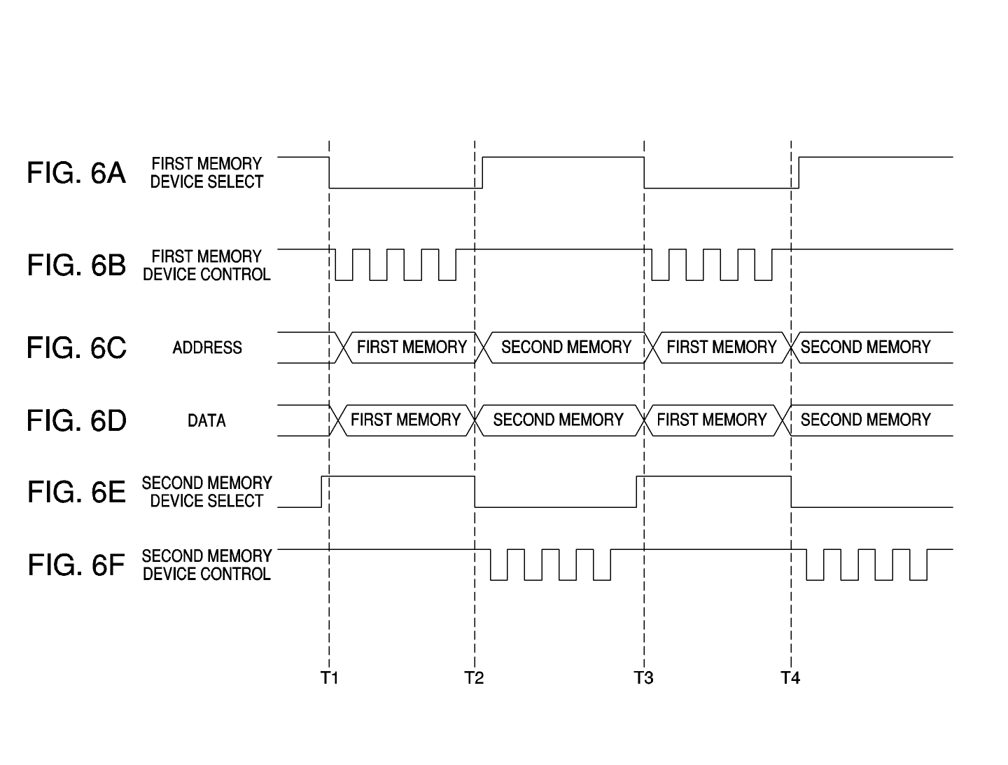

Turning now to FIGS. 6A-6F, an example of the operation of the control system 10 is described. The controller 12 outputs an active low signal to select the first memory device 14 at time Ti (FIG. 6A). This opens a communication between the controller 12 and the first memory device 14 via shared pins 20 to enable control signals, such as RAS, CAS, WE, etc., to be transmitted between the two devices (FIG. 6B). Data (FIG. 6D) and addresses (FIG. 6C) for the first memory device 14 are also transmitted between the controller 12 and the first memory device starting at time T1 through shared pins 20 and unique pins 22, respectively. The second memory device 16 is inactive at this time (FIGS. 6E and 6F), since it is not selected by the controller 12.

At time T2, the controller 12 goes active high with respect to the first memory device 14 (FIG. 6A) and goes active low to select the second memory device 16 (FIG. 6E). This opens a communication between the controller 12 and the second memory device 16 via shared pins 20 to enable control signals (FIG. 6F), such as AVD, WE, OE, etc., to be transmitted between the two devices. Data (FIG. 6D) and addresses (FIG. 6C) for the second memory device 16 are also transmitted between the controller 12 and the second memory device starting at time T2 through shared pins 20 and unique pins 22, respectively.

At time T3, the first memory device 14 (FIG. 6A) is again selected and the process starting at time T1 is repeated. At time T4, the second memory device 16 (FIG. 6E) is again selected and the process starting at T2 is repeated.

The embodiments and examples set forth herein were presented in order to best explain the present invention and its practical application and to thereby enable those skilled in the art to make and use the invention. Those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the forthcoming claims.

Various features of the invention are set forth in the appended claims.

What is claimed is:

1. A control system, comprising:
a controller having a plurality of shared pins and a plurality of unique pins for receiving and outputting signals;
a first memory device having a plurality of first signal lines, select first signal lines being electrically connected to select shared pins; and
a second memory device having a plurality of second signal lines, select second signal lines being electrically connected to the select shared pins together with the select first signal lines;
wherein said controller selectively inputs signals from and output signals to the first memory device and second memory device through the select shared pins.

2. The control system as defined in claim 1, wherein the shared pins comprises shared input pins for receiving input signals from the first and second memory devices, and shared output pins for outputting output signals to the first and second memory devices.

3. The control system as defined in claim 2, wherein the controller further comprises:
shared input pads electrically connected to the shared input pins for receiving input signals from the first and second memory devices;
shared output pads electrically connected to the shared output pins for outputting output signals to the first and second memory devices;
input circuitry connected to corresponding one of the shared input pads for receiving input signals from the first and second memory devices connected to the corresponding shared input pin; and
output circuitry connected to corresponding one of the shared output pads for outputting output signals to the first and second memory devices connected to the corresponding shared output pin.

4. The control system as defined in claim 3, wherein said controller further comprises:
an input selector in communication with the input circuitry for selecting input signals to be received by the controller from the first memory device or the second memory device received through the input circuitry; and
an output selector in communication with the output circuitry for selecting output signals to be output by the controller to the first memory device or the second memory device through the output circuitry.

5. The control system as defined in claim 4, wherein the input circuitry comprises:
a first input structure for receiving input signals from the first memory device via the corresponding shared input pad, and a second input structure for receiving input signals from the second memory device via the corresponding shared input pad; and
the output circuitry includes a first output structure for outputting output signals to the first memory device via the corresponding shared output pad, and a second output structure for outputting output signals to the second memory device via the corresponding shared output pad.

6. The control system as defined in claim 5, wherein the first input structure switches logic state at a first threshold voltage relative to an operating voltage of the first memory device, and the second input structure switches logic state at a second threshold voltage relative to an operating voltage of the second memory device.

7. The control system as defined in claim 1, wherein the first memory device comprises a buffer memory and the second memory device comprises a non-volatile memory.

8. The control system as defined in claim 1, wherein the shared pins comprises shared input/output pins for receiving input signals from and outputting output signals to the first and second memory devices.

9. The control system as defined in claim 8, wherein the controller further comprises:
shared input/output pads electrically connected to the shared input/output pins for receiving input signals from and outputting output signals to the first and second memory devices;
input circuitry connected to corresponding one of the shared input/output pads for receiving input signals from the first and second memory devices connected to the corresponding shared input/output pin; and
output circuitry connected to the corresponding one of the shared input/output pads for outputting output signals to the first and second memory devices connected to the corresponding shared input/output pin.

10. The control system as defined in claim 9, wherein said controller further comprises:
an input selector in communication with the input circuitry for selecting input signals to be received by the controller from the first memory device or the second memory device received through the input circuitry; and
an output selector in communication with the output circuitry for selecting output signals to be output to the first memory device or the second memory device through the output circuitry.

11. The control system as defined in claim 10, wherein the input circuitry comprises:
a first input structure for receiving input signals from the first memory device via the corresponding shared input/output pad, and a second input structure for receiving input signals from the second memory device via the corresponding shared input/output pad; and
the output circuitry includes a first output structure for outputting output signals to the first memory device via the corresponding shared input/output pad, and a second output structure for outputting output signals to the second memory device via the corresponding shared input/output pad.

12. The control system as defined in claim 11, wherein the first input structure switches logic state at a first threshold voltage relative to an operating voltage of the first memory device, and the second input structure switches logic state at a second threshold voltage relative to an operating voltage of the second memory device.

13. A method for configuring input and output signal connections between a controller and multiple memory devices, comprising:
providing the controller with a plurality of shared pins and a plurality of unique pins for receiving and outputting signals;
connecting select first signal lines of a first memory device to select shared pins; and
connecting select second signal lines of a second memory device to the select shared pins together with the select first signal lines;
wherein the controller selectively inputs signals from and output signals to the first memory device and second memory device through the select shared pins.

14. The method as defined in claim 13, wherein the shared pins comprises shared input pins for receiving input signals from the first and second memory devices, and shared output pins for outputting output signals to the first and second memory devices.

15. The method as defined in claim 14, further comprising:
connecting input circuitry in the controller to a corresponding shared input pin for receiving input signals from the first memory device and the second memory device; and
connecting output circuitry to a corresponding shared output pin for outputting output signals to the first memory device and the second memory devices.

16. The method as defined in claim 15, further comprising:
providing an input selector in communication with the input circuitry for selecting input signals to be received by the controller from the first memory device or the second memory device received through the input circuitry; and
providing an output selector in communication with the output circuitry for selecting output signals to be output by the controller to the first memory device or the second memory device through the output circuitry.

17. The method as defined in claim 16, wherein the shared pins comprises shared input/output pins for receiving input signals from and outputting output signals to the first and second memory devices.

18. The method as defined in claim 17, further comprising:
connecting input circuitry in the controller to a corresponding shared input/output pin for receiving input signals from the first memory device and the second memory device; and
connecting output circuitry to the corresponding shared input/output pin for outputting output signals to the first memory device and the second memory devices.

19. The method as defined in claim 18, further comprising:
providing an input selector in communication with the input circuitry for selecting the input signals to be received by the controller from the first memory device or the second memory device received through the input circuitry; and
providing an output selector in communication with the output circuitry for selecting output signals to be output by the controller to the first memory device or second memory device through the output circuitry.

20. A disk device having at least one disk medium, comprising:
a disk controller having a plurality of shared pins and a plurality of unique pins for receiving and outputting signals;
a buffer memory having a plurality of first signal lines, select first signal lines being electrically connected to select shared pins; and
a non-volatile memory having a plurality of second signal lines, select second signal lines being electrically connected to the select shared pins together with the select first signal lines;
wherein said controller selectively inputs signals from and output signals to the buffer memory and the non-volatile memory through the select shared pins.

21. The disk device as defined in claim 20, wherein the shared pins comprises shared input pins for receiving input signals from the buffer memory and the non-volatile memory, and shared output pins for outputting output signals to the buffer memory and the non-volatile memory.

22. The disk device as defined in claim 20, wherein the shared pins comprises shared input/output pins for receiving the input signals from and outputting the output signals to the buffer memory and the non-volatile memory.
